(19) United States
(12) Patent Application Publication
(10) Pub. No.: US 2022/0044512 A1
(43) Pub. Date: Feb. 10, 2022

(54) BALLOT PROCESSING DEVICE, SYSTEM, AND METHOD FOR SECRET BALLOT

(71) Applicant: AVISION INC., Hsinchu (TW)

(72) Inventor: CHUN-CHIEH LIAO, Hsinchu (TW)

(21) Appl. No.: 17/342,553

(22) Filed: Jun. 9, 2021

(30) Foreign Application Priority Data
Aug. 10, 2020 (TW) 109127088

(51) Int. Cl. G07C 13/00; G06Q 10/10

(52) U.S. Cl. CPC G07C 13/00; G06Q 2230/00; G06Q 10/10

(57) ABSTRACT

A ballot processing device, system, and method for a secret ballot are introduced. The ballot processing method, executed with a multifunction printer (MFP) connected to a remote end through a network, includes inputting at least one ballot image and assigning thereto a unique code each; creating a tamper-proof reference ballot file according to the ballot image having the unique code; sending the tamper-proof reference ballot file to the remote end, and outputting a paper reference ballot accordingly. Creating the tamper-proof reference ballot file according to the ballot image having the unique code and outputting the paper reference ballot ensures the security and accuracy of the paper reference ballot. In addition, the unique code enables a quick check. Therefore, the security, reliability and check efficiency of ballots is improved.

### CROSS-REFERENCE TO RELATED APPLICATION

This non-provisional application claims priority under 35 U.S.C. § 119(a) on Patent Application No(s). 109127088 filed in Taiwan, R.O.C. on Aug. 10, 2020, the entire contents of which are hereby incorporated by reference.

### BACKGROUND OF THE INVENTION

### 1. Field of the Invention

The present disclosure relates to ballot processing devices, systems and methods, and in particular to a ballot processing device, system and method for a secret ballot.

### 2. Description of the Related Art

Owing to ever-changing technology, important electronic data are often transmitted via a network to cloud and computer apparatuses and stored therein. In doing so, the ease of accessing and processing data is enhanced, but the electronic data may be stolen, tampered or forged. To avoid this, important data are presented in paper format. This, however, has disadvantages as follows: counting, confirming and/or checking the paper-format data by hand are/is predisposed to human-made errors, fraudulent activities, and counterfeits. For instance, to finish an election, ballots are counted by hand, albeit at the risk of undercounting and overcounting the ballots, let alone adding to the difficulties in subsequent verification of the ballots. Secret ballots are processed by hand and thus result in disadvantages: inefficiency, lack of reliability, and human-made errors; these disadvantages cannot be overcome by existing networks, media, and the general public monitoring polling and counting ballots.

### BRIEF SUMMARY OF THE INVENTION

An objective of the present disclosure is to provide a ballot processing device, system and method for a secret ballot, allowing a unique code to be assigned to a ballot image, such that a tamper-proof reference ballot file is created according to the ballot image having the unique code, so as to ensure ballot security and accuracy. Furthermore, the ballots can be quickly checked according to the unique code on the ballot. Therefore, the security, reliability and check efficiency of ballots is improved.

To achieve at least the above objective, the present disclosure provides a ballot processing method for a secret ballot, the ballot processing method being executed with a multifunction printer connected to a remote end via a network and comprising the steps of:
inputting at least one ballot image and assigning a unique code to the ballot image;
creating a tamper-proof reference ballot file according to the ballot image having the unique code; and
sending the tamper-proof reference ballot file to the remote end and outputting a paper reference ballot accordingly.

Regarding the method, the unique code is assigned to the ballot image, and the tamper-proof reference ballot file is created according to the ballot image having the unique code, so as to ensure the security and accuracy of ballots. The unique codes enable a quick check. Therefore, the security, reliability and check efficiency of ballots is improved.

With the tamper-proof reference ballot files being stored at a remote end, file preservation is convenient, safe and reliable.

To achieve at least the above objective, the present disclosure provides a ballot processing system for a secret ballot, comprising:
a ballot backup server located at a remote end and connected to a network; and
at least one multifunction printer connected to the ballot backup server via the network,
wherein at least one ballot image is input to the multifunction printer and assigned with a unique code each, and then a tamper-proof reference ballot file is created according to the ballot image having the unique code,
wherein the multifunction printer sends the tamper-proof reference ballot file to the ballot backup server via a network and outputs a paper reference ballot accordingly.

Regarding the system, the unique code is assigned to the ballot image, and the tamper-proof reference ballot file is created according to the ballot image having the unique code, so as to ensure the security and accuracy of ballots. The unique codes enable a quick check. Therefore, the security, reliability and check efficiency of ballots is improved.

With the tamper-proof reference ballot files being stored at a remote end, file preservation is convenient, safe and reliable.

To achieve at least the above objective, the present disclosure provides a ballot processing device for a secret ballot, comprising a multifunction printer, the multifunction printer comprising:
a scanner for capturing an image of a ballot;
a storing unit; and
a processing module connected to the scanner, the printer, and the storing unit,
wherein the scanner captures at least one ballot image, such that the processing module assigns a unique code to the ballot image, creates a tamper-proof reference ballot file according to the ballot image having the unique code, and stores the tamper-proof reference ballot file in the storing unit, allowing the printer to output a paper reference ballot accordingly.

Regarding the device, the unique code is assigned to the ballot image, and the tamper-proof reference ballot file is created according to the ballot image having the unique code, so as to ensure the security and accuracy of ballots. The unique codes enable a quick check. Therefore, the security, reliability and check efficiency of ballots is improved.

### BRIEF DESCRIPTION OF THE DRAWINGS

FIG. 1 is a block diagram of a ballot processing system according to an embodiment of the present disclosure.

FIG. 2 is a block diagram of the ballot processing device according to an embodiment of the present disclosure.

FIG. 3 is a schematic view of a process flow of a ballot processing method according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

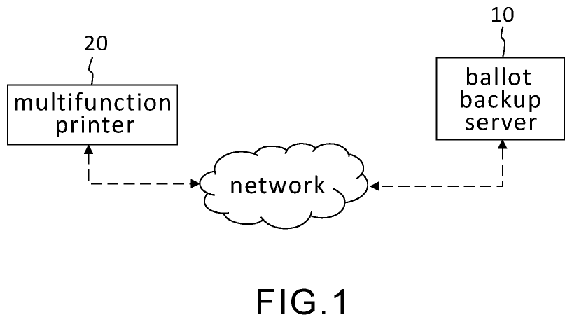

Referring to FIG. 1, a ballot processing system for a secret ballot is provided according to an embodiment of the present disclosure. The ballot processing system comprises a ballot backup server 10 at a remote end and at least one ballot processing device. The ballot processing device comprises a multifunction printer 20. The ballot backup server 10 is connected to a network. The multifunction printer 20 is connected to the ballot backup server 10 via the network. In this embodiment, the ballot backup server 10 is dedicated to a competent authority in charging of polling.

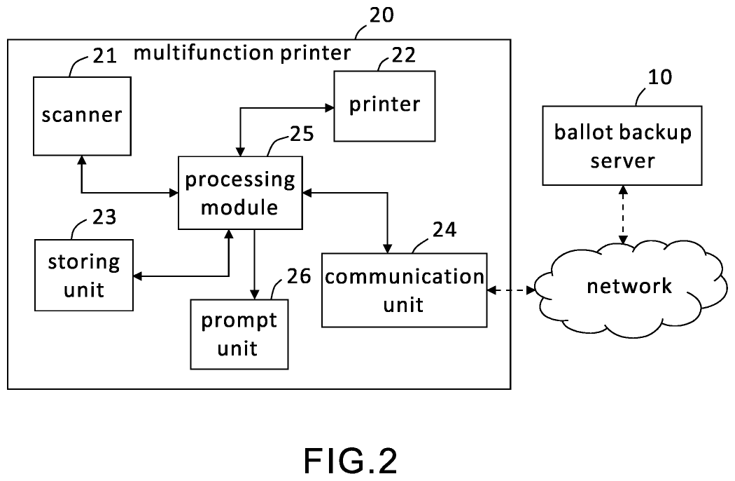

Referring to FIGS. 1, 2, the multifunction printer 20 comprises a scanner 21, a printer 22, a storing unit 23, a communication unit 24 and a processing module 25. The processing module 25 is connected to the scanner 21, the printer 22, the storing unit 23 and the communication unit 24.

In an embodiment, the multifunction printer 20 further comprises a prompt unit 26. The prompt unit 26 is connected to the processing module 25 and adapted to send a prompt.

The scanner 21 receives at least one paper ballot and thereby inputs at least one ballot image to be stored in the storing unit 23 by the processing module 25. The scanner 21 is a sheet-fed scanner. The printer 22 outputs paper ballots. The storing unit 23 stores related files and data. The storing unit 23 comprises a memory, including but not limited to Dynamic Random Access Memory (DRAM), Flash memory, Hard Disk Drive (HDD), and Solid-State Drive (SSD). Data are exchanged between the communication unit 24 and the ballot backup server 10. The communication unit 24 comprises a Wi-Fi unit or a 2G, 3G, 4G, 5G or higher mobile communication unit. The processing module 25 is a CPU. The prompt unit 26 comprises a speaker and a light-emitting unit, such as LED.

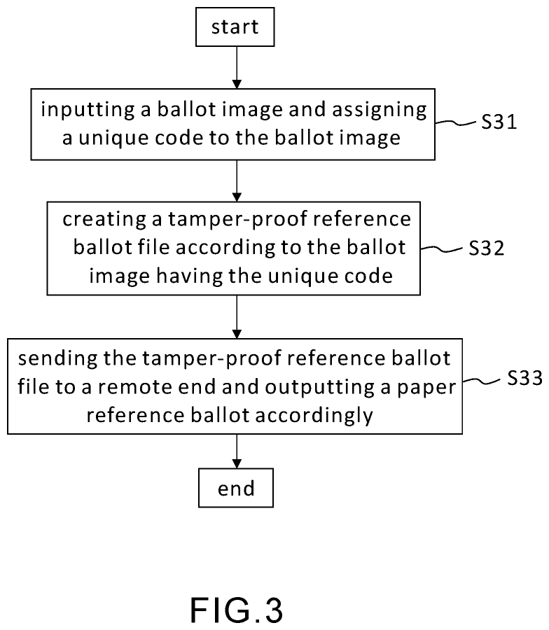

Referring to FIG. 3, in an embodiment, a ballot processing method is executed with the multifunction printer 20 and comprises the steps of:
inputting at least one ballot image and assigning a unique code to the ballot image (S31);
creating a tamper-proof reference ballot file according to the ballot image having the unique code (S32); and
sending the tamper-proof reference ballot file to the remote end and outputting a paper reference ballot accordingly (S33).

The multifunction printer 20 executes step S31. In step S31, a user places at least one paper ballot on the scanner 21, such that the scanner 21 captures at least one ballot image accordingly and stores the at least one ballot image captured in the storing unit 23. The processing module 25 generates a unique code according to the ballot image retrieved from the storing unit 23. The processing module 25 assigns the unique code to the ballot image.

Upon completion of step S31, the multifunction printer 20 executes step S32. In step S32, the processing module 25 creates a tamper-proof reference ballot file according to the ballot image having the unique code. The tamper-proof reference ballot file comprises the unique code. The tamper-proof reference ballot file having the unique code cannot be tampered and thus is safe.

Upon completion of step S32, the multifunction printer 20 executes step S33. In step S33, the processing module 25 sends, via the communication unit 24, the tamper-proof reference ballot file to the ballot backup server 10 for storage. The processing module 25 controls the printer 22 to output a paper reference ballot according to the tamper-proof reference ballot file.

In an embodiment, the multifunction printer 20 generates a unique code every time a paper ballot is scanned, and then the multifunction printer 20 assigns the unique code to the ballot image. In an embodiment, the multifunction printer 20 generates multiple unique codes only after multiple paper ballots have been scanned, and then the multifunction printer 20 sequentially assign the multiple unique codes to the ballot images, respectively.

In an embodiment, the unique code comprises a serial number and a category datum. The serial number comprises a dynamic continuous number. The category datum comprises a region datum, a polling booth datum, a subject datum, a time datum, a shop datum or an issue datum.

The dynamic continuous number increases by 1 every time the processing module 25 fetches a ballot image. For example, the dynamic continuous number is initially A001. When the processing module 25 fetches the first ballot image from the storing unit 23, the processing module 25 generates the unique code (A001) and assigns the unique code (A001) to the first ballot image. Furthermore, the processing module 25 increases the dynamic continuous number by 1, such that the dynamic continuous number changes from A001 to A002. The unique code includes the dynamic continuous number, such that the ballot images are arranged in sequence and thus can be easily counted and checked. Thus, if a ballot image is wrong, the sequence of preceding ballot images and subsequent ballot images can be confirmed according to their unique codes.

The region datum includes a zone number, zone code and zip code. The polling booth datum includes a polling booth's code and reference number. The subject datum includes a subject's code and reference number. The time datum includes year, month, day, hour and/or minute. The shop datum includes a shop's code, reference number, and phone number. The issue datum includes an issue number, issue reference number, and issue code.

In an embodiment, each ballot image having the unique code is in PDF format. The ways in which the processing module 25 generates the tamper-proof reference ballot file are illustrated by embodiments below. The processing module 25 executes a digital signature procedure to attach a digital certificate to the PDF-format ballot image having the unique code and encrypt it, so as to generate the tamper-proof reference ballot file. If the tamper-proof reference ballot file is tampered, the attached digital certificate will disappear. Therefore, preservation security of the tamper-proof reference ballot file is ensured. The encryption involves encrypting the ballot file with a public key and a private key, thereby further enhancing file security. The tamper-proof reference ballot file is in PDF format. The digital certificate is attached to only one ballot image having the unique code. Alternatively, the digital certificates are simultaneously attached to multiple ballot images having the unique codes, respectively.

In an embodiment, in the absence of any network, after executing step S32, the multifunction printer 20 stores the tamper-proof reference ballot file, and the printer 22 outputs the paper reference ballot. Thus, in this embodiment, it is only when a network is available that the multifunction printer 20 starts the communication unit 24 and connects to the network via the communication unit 24. The processing module 25 sends, via the communication unit 24, the tamper-proof reference ballot file to the ballot backup server 10 for storage. In the absence of any network, after the tamper-proof reference ballot file has been generated, the multifunction printer 20 outputs the paper reference ballot. In the presence of a network, the multifunction printer 20 sends the tamper-proof reference ballot file to the ballot backup server 10 for storage and outputs the paper reference ballot. Therefore, flexibility and ease of use is enhanced.

In an embodiment, to check the paper reference ballot, the scanner 21 captures the image of the paper reference ballot thus output. The processing module 25 executes a check process whereby the unique code in the image of the paper reference ballot is compared with the unique code of the tamper-proof reference ballot file stored in the storing unit 23 to generate a comparison result. The processing module 25 generates a prompt datum when the comparison result shows that their unique codes are different. The processing module 25 controls the prompt unit 26 to send the prompt datum. The prompt datum is a prompt sound or a prompt light.

In another embodiment, the captured image of the paper reference ballot output is sent by the multifunction printer 20 to the ballot backup server 10 to undergo comparison. If the comparison result shows that their unique codes are different, the ballot backup server 10 returns the prompt datum to the multifunction printer 20. The processing module 25 controls the prompt unit 26 to send the prompt datum.

The aforesaid technical features are further illustrated with an application situation. For example, at least one aforesaid multifunction printer 20 is provided at each of different polling and counting booths. The polling termination time varies from polling and counting booth to polling and counting booth, so is the time of commencement of the ensuing ballot processing process which involves placing the ballots at the multifunction printer 20, scanning the ballots one by one and counting the ballots with the scanner 21 (for example, a sheet-fed scanner) of the multifunction printer 20 to calculate the ballot count of each polling and counting booth, assigning a unique code to each ballot image, creating their tamper-proof reference ballot files, respectively, and uploading all the tamper-proof reference ballot files to the ballot backup server 10 dedicated to a competent authority in charging of polling or locally storing all the tamper-proof reference ballot files in the multifunction printer 20. Furthermore, the multifunction printer 20 controls the printer 22 to output all the tamper-proof reference ballot files one by one as paper reference ballots, respectively. The paper reference ballots can be safely, conveniently and efficiently compared with the reference ballot files kept by a competent authority in charging of polling to check the ballots. Therefore, the security, reliability and check efficiency of ballots is improved.

While the present disclosure has been described by means of specific embodiments, numerous modifications and variations could be made thereto by those skilled in the art without departing from the scope and spirit of the present disclosure set forth in the claims.

What is claimed is:

1. A ballot processing method for a secret ballot, the ballot processing method being executed with a multifunction printer connected to a remote end via a network and comprising the steps of:
inputting at least one ballot image and assigning a unique code to the ballot image;
creating a tamper-proof reference ballot file according to the ballot image having the unique code; and
sending the tamper-proof reference ballot file to the remote end and outputting a paper reference ballot accordingly.

2. The ballot processing method for a secret ballot according to claim 1, wherein the unique code comprises a serial number and a category datum.

3. The ballot processing method for a secret ballot according to claim 2, wherein the serial number comprises a dynamic continuous number, and the dynamic continuous number increases by 1 in response to each additional ballot image captured.

4. The ballot processing method for a secret ballot according to claim 3, wherein the category datum comprises a region datum, a polling booth datum, a subject datum, a time datum, a shop datum or an issue datum.

5. The ballot processing method for a secret ballot according to claim 4, wherein a digital certificate is not only attached to the ballot image having the unique code but also encrypted to generate the tamper-proof reference ballot file.

6. The ballot processing method for a secret ballot according to claim 5, further comprising a check process, the check process comprising the step of fetching the paper reference ballot output and comparing its unique code with the unique code of the tamper-proof reference ballot file stored to generate a comparison result.

7. A ballot processing system for a secret ballot, comprising:
a ballot backup server located at a remote end and connected to a network; and
at least one multifunction printer connected to the ballot backup server via the network,
wherein at least one ballot image is input to the multifunction printer and assigned with a unique code each, and then a tamper-proof reference ballot file is created according to the ballot image having the unique code,
wherein the multifunction printer sends the tamper-proof reference ballot file to the ballot backup server via a network and outputs a paper reference ballot accordingly.

8. The ballot processing system for a secret ballot according to claim 7, wherein the unique code comprises a serial number and a category datum.

9. The ballot processing system for a secret ballot according to claim 8, wherein the serial number comprises a dynamic continuous number, and the dynamic continuous number increases by 1 in response to each additional ballot image captured.

10. The ballot processing system for a secret ballot according to claim 9, wherein the category datum comprises a region datum, a polling booth datum, a subject datum, a time datum, a shop datum or an issue datum.

11. The ballot processing system for a secret ballot according to claim 10, wherein a digital certificate is not only attached to the ballot image having the unique code but also encrypted to generate the tamper-proof reference ballot file.

12. The ballot processing system for a secret ballot according to claim 11, wherein the multifunction printer fetches the paper reference ballot output and compares its unique code with the unique code of the tamper-proof reference ballot file stored to generate a comparison result.

13. A ballot processing device for a secret ballot, comprising a multifunction printer, the multifunction printer comprising:
a scanner for capturing an image of a ballot;
a printer for outputting a paper;
a storing unit; and
a processing module connected to the scanner, the printer, and the storing unit,
wherein the scanner captures at least one ballot image, such that the processing module assigns a unique code to the ballot image, creates a tamper-proof reference ballot file according to the ballot image having the unique code, and stores the tamper-proof reference ballot file in the storing unit, allowing the printer to output a paper reference ballot accordingly.

14. The ballot processing device for a secret ballot according to claim 13, wherein the unique code comprises a serial number and a category datum.

15. The ballot processing device for a secret ballot according to claim 14, wherein the serial number comprises a dynamic continuous number, and the dynamic continuous number increases by 1 in response to each additional ballot image captured.

16. The ballot processing device for a secret ballot according to claim 15, wherein the category datum comprises a region datum, a polling booth datum, a subject datum, a time datum, a shop datum or an issue datum.

17. The ballot processing device for a secret ballot according to claim 16, wherein a digital certificate is not only attached to the ballot image having the unique code but also encrypted to generate the tamper-proof reference ballot file.

18. The ballot processing device for a secret ballot according to claim 17, further comprising a communication unit connected to a ballot backup server at a remote end via a network and connected to the processing module, wherein the processing module controls the communication unit to send, via the network, the tamper-proof reference ballot file to the ballot backup server for storage.

19. The ballot processing device for a secret ballot according to claim 18, further comprising a prompt unit connected to the processing module, wherein the processing module receives the paper reference ballot from the scanner, compares the unique code of the paper reference ballot received with the unique code of the tamper-proof reference ballot file stored to generate a comparison result, and controls the prompt unit to send a prompt datum when the comparison result shows that their unique codes are different.
